(19) United States
(12) Patent Application Publication
(10) Pub. No.: US 2017/0246588 A1
(43) Pub. Date: Aug. 31, 2017

(54) ADSORPTION SYSTEM WITH CIRCULATING ADSORBENT ARRANGEMENT

(71) Applicant: ANTECY B.V., HOEVELAKEN (NL)

(72) Inventors: Timo ROESTENBERG, SCHALKHAAR (NL); Paul O'CONNOR, HOEVELAKEN (NL)

(73) Assignee: ANTECY B.V., HOEVELAKEN (NL)

(21) Appl. No.: 15/516,077

(22) PCT Filed: Oct. 1, 2015
(86) PCT No.: PCT/EP2015/072761

§ 371 Date: Mar. 31, 2017

Related U.S. Application Data
(60) Provisional application No. 62/058,117, filed on Oct. 1, 2014.

(51) Int. Cl. B01D 53/62; B01D 53/26; B01D 53/83

(52) U.S. Cl. CPC B01D 53/62; B01D 53/83; B01D 53/261; B01D 2251/306; B01D 2251/606; B01D 2253/25; B01D 2257/504

(57) ABSTRACT

A reactor system for conducting an adsorption/desorption swing process comprising of at least o adsorption reactor; at least one desorption reactor and means for transporting a particulate adsorbent material between the at least one adsorption reactor and the at least one desorption reactor.

This invention addresses a problem encountered with the implementation of the process disclosed in PCT/EP/2013/065074, the disclosures of which are incorporated herein by reference. In this process, the adsorption of CO₂ occurs in atmospheric ambient conditions, and takes a certain amount of exposure time to air. The desorption takes place under such vacuum to allow dry steam to displace the air remaining from the adsorption stage. The desorption stage generally takes much longer than the adsorption stage. For example, adsorption can be configured such that it takes 22 hours, desorption can be configured to take place in 2 hours, for a combined 24 hr cycle.

When using fixed, non moving beds, each vessel performs both the function of adsorber and desorber, and must thus be able to withstand evacuation and be heated. However, these functions are only needed a fraction of the time (during desorption), during adsorption the vessels are ambient pressure and temperature.

It may for this reason be economical to construct a system where the adsorbent travels from the stage/vessel/location where it adsorbs CO₂ at ambient pressure and temperature, to a stage/vessel/location where it is desorbed under vacuum and higher temperature conditions. In this way, the vessel that is used for desorption is in continuous use and the capital expenditure for the construction of this desorption vessel more efficiently employed.

As examples of this concept the following to embodiments are included:
Small particles, contact with air during transport
Fixed bed air contact

In the small particles, contact with air during transport concept, the particles are transported by the air that is to act as a CO₂ source from a buffer vessel to an air-particle separator. The air from which CO₂ is adsorbed thus acts as a transport medium for the particles. After separation from the air, the particles are temporarily stored in a buffer vessel before being regenerated batch wise.

Alternate forms of particle transport may be used, such as conveyor systems, pneumatic transport, spouted bed reactors, risers as used in fluid catalytic cracking, and the like.

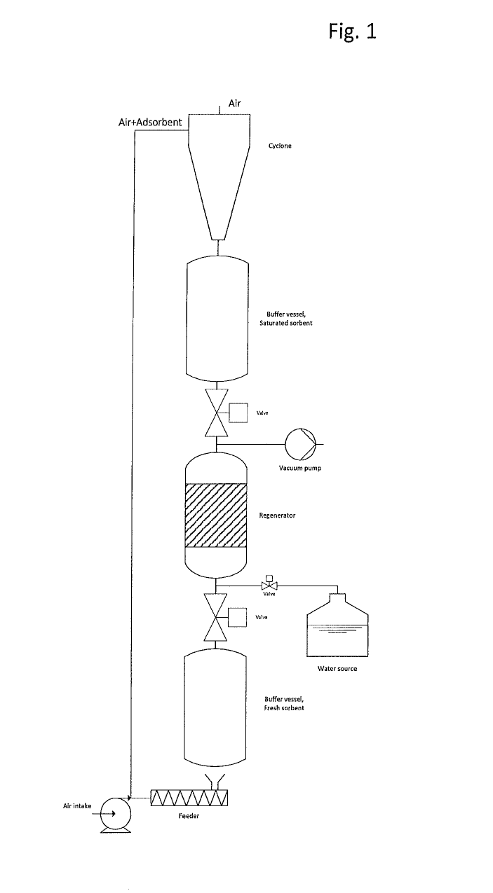

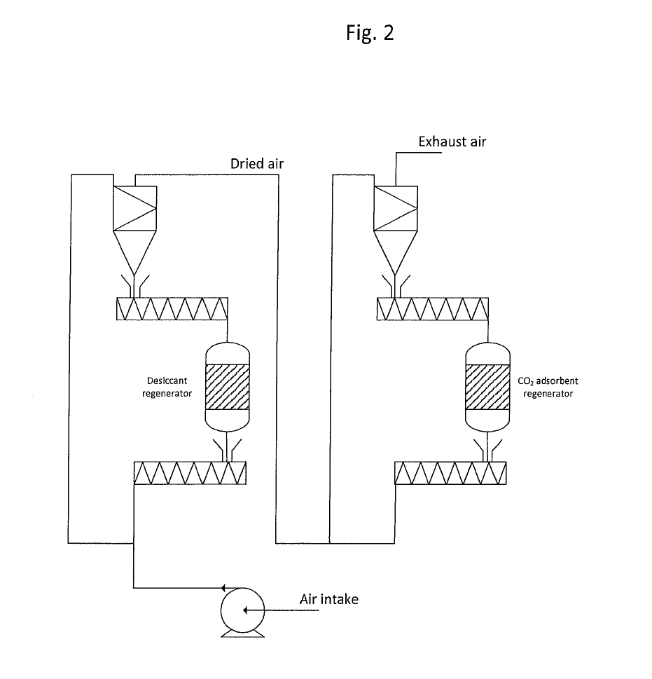

An additional embodiment may be the addition of water vapor adsorbing particles (desiccant) either as a separate contacting/regenerating step, or mixed in directly with the CO₂ adsorbing particles, to shift the equilibrium towards more CO₂ adsorbed. In the FIGS. 1 and 2 the “Small particles, contact with air during transport” is illustrated.

Small particles, contact with air during transport, pre-drying particles and CO₂ adsorbing particles in series (buffer vessels and regenerating vacuum pump not shown) is illustrated in FIG. 2.

In an alternate embodiment, the “fixed bed air contact”, two vessel types filled with solid particles, for example pill size are employed. In the first vessel type, CO₂ is adsorbed from ambient air. When the sorbent is saturated, it is conveyed to a separate vessel, where it is regenerated. After regeneration is complete, the sorbent is conveyed back to the adsorbing vessel. When more adsorbing vessels are present than desorbing vessels (for example, 10 adsorbing vessels for every one desorbing vessel), the difference in cycle time for the two stages can be compensated for.

Again, there is the option of adding a desiccant to the adsorbing material, or having a separate drying step prior to CO₂ adsorption.

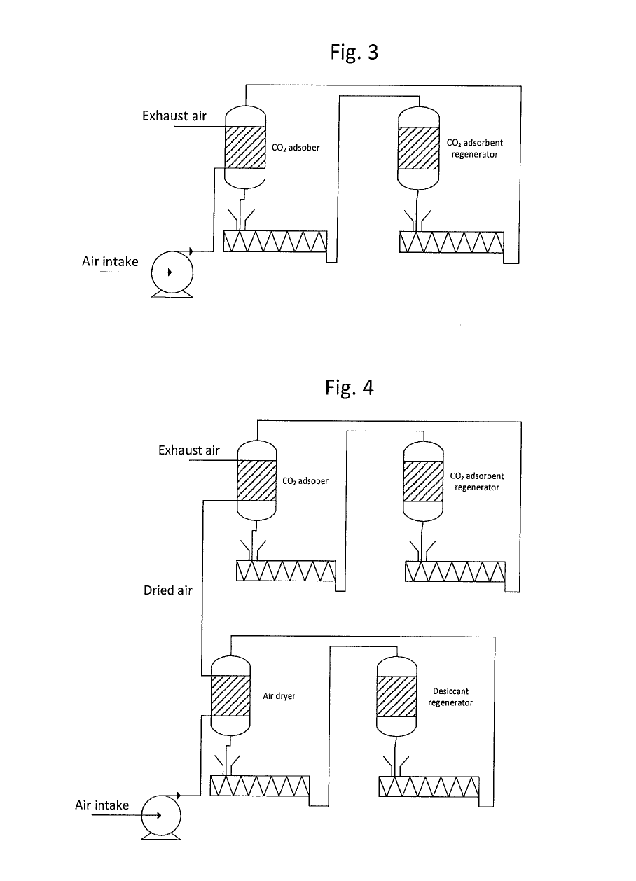

Fixed bed air contact is illustrated in FIG. 3.

Fixed bed air contact, with pre-drying bed is illustrated in FIG. 4.

The invention optimizes the use of the equipment, and confines the need for a vacuum resistant construction to only a relatively small portion of the equipment, being the desorber and its associated conduits. This significantly reduces the capital investment costs.

1. A reactor system for conducting an adsorption/desorption swing process comprising:
a. at least one adsorption reactor;
b. at least one desorption reactor;
c. means for transporting a particulate adsorbent material between the at least one adsorption reactor and the at least one desorption reactor.

2. The reactor system of claim 1 comprising at least two adsorption reactors for every desorption reactor.

3. The reactor system of claim 2 comprising at least three adsorption reactors for every desorption reactor.

4. The reactor system of any one of the preceding claims wherein the means for transporting comprises a conveying gas.

5. The reactor system of any one of the preceding claims wherein the means for transporting comprises a means for removing fines from the particulate adsorbent material.

6. The reactor system of any one of the preceding claims comprising a means for replenishing particulate adsorbent material.

7. The reactor system of any one of the preceding claims wherein the adsorption/desorption swing process is a carbon dioxide adsorption/desorption swing process.

8. The reactor system of claim 7 wherein the swing process comprises a temperature swing, a pressure swing, a moisture swing, or a combination thereof.

9. The reactor system of claim 7 or 8 wherein the carbon dioxide adsorption swing process comprises adsorption of carbon dioxide from atmospheric air.

10. The reactor system of any one of claims wherein the particulate adsorbent comprises an oxide or salt capable of forming a carbonate or a bicarbonate upon contact with carbon dioxide.

11. The reactor system of claim 10 wherein the particulate adsorbent comprises potassium carbonate.

12. The reactor system of claim 11 wherein the particulate adsorbent comprises potassium carbonate sesquihydrate.

13. The reactor system of any one of claims 10 through 12 wherein the oxide or salt is present on a particulate support.

14. The reactor system of claim 13 wherein the support is selected from activated carbon, alumina, and silica
